(19) United States
(12) Patent Application Publication
(10) Pub. No.: US 2025/0206231 A1
(43) Pub. Date: Jun. 26, 2025

(54) VEHICLE

(71) Applicant: HONDA MOTOR CO., LTD., Tokyo (JP)

(72) Inventors: Kosuke Ito, Tokyo (JP); Hiroyuki Ueyama, Tokyo (JP); Hirofumi Uchiyama, Tokyo (JP); Yuka Minegishi, Tokyo (JP); Mizuki Matsui, Tokyo (JP); Masaki Suto, Tokyo (JP)

(21) Appl. No.: 18/988,980

(22) Filed: Dec. 20, 2024

(30) Foreign Application Priority Data
Dec. 26, 2023 (JP) 2023-219477

(51) Int. Cl. B60R 1/29

(52) U.S. Cl. CPC B60R 1/29

(57) ABSTRACT

A vehicle includes a center display, a side display for a side camera monitor system, and an imaging camera which is configured to image an interior of a vehicle cabin, wherein the imaging camera is disposed above the side display and is disposed on a center side of the vehicle.

### CROSS-REFERENCE TO RELATED APPLICATION

Priority is claimed on Japanese Patent Application No. 2023-219477, filed Dec. 26, 2023, the content of which is incorporated herein by reference.

### BACKGROUND OF THE INVENTION

### Field of the Invention

The present invention relates to a vehicle.

### Description of Related Art

In recent years, the number of vehicles equipped with cameras that capture images inside a vehicle cabin has been increasing. However, there is a problem with where to install the cameras in order to capture images of the entire interior of the vehicle cabin. For example, Patent Documents 1 and 2 listed below describe vehicles in which a camera is installed on a ceiling of a vehicle cabin.

[Patent Document 1] Japanese Unexamined Patent Application, First Publication No. 2012-126357

[Patent Document 2] Japanese Unexamined Patent Application, First Publication No. 2019-219899

### SUMMARY OF THE INVENTION

Conventional cameras inside the vehicle cabin are often installed at a front upper portion of the vehicle center. In this case, a shooting angle inside the vehicle cabin is fixed to one angle, and it is difficult to capture an image of the entire interior of the vehicle cabin. When a camera is installed inside the vehicle cabin, it is desirable to maintain a sense of unity in the interior of the vehicle while not interfering with a driver's driving.

An aspect of the present invention has been made in consideration of the above-described circumstances, and one of objects thereof is to provide a vehicle that can capture an image of the entire interior of a vehicle cabin from an imaging camera without interfering with a driver's driving.

In order to solve the above problems, the present invention employs the following aspects.

(1): A vehicle according to an aspect of the present invention includes a center display, a side display for a side camera monitor system, and an imaging camera configured to image an interior of a vehicle cabin, wherein the imaging camera is disposed above the side display and on a center side of the vehicle.

With the above configuration, since the imaging camera is disposed to capture an image of the interior of the vehicle from the side of the driver without interfering with the driver's driving, the imaging camera is unlikely to be hidden behind bodies of a driver and a passenger sitting next to the driver, and can capture an image of the entire interior of the vehicle.

(2): In the aspect of (1), the vehicle may further include a connection portion between the center display and the side display, and the imaging camera may be disposed within a range of the center display in a height direction.

In this case, the imaging camera does not protrude upward from the center display in a height direction, and therefore does not interfere with the driver's driving. Since the imaging camera does not protrude downward in the height direction of the center display, it is possible to capture an image of the entire interior of the vehicle cabin.

(3): In the aspect of (2), the imaging camera may include a connection terminal on a center display side, and the connection terminal may be disposed in a range of the connection portion.

In this case, even when the connection terminal of the imaging camera protrudes from the side display, it can be accommodated between the side display and the center display.

(4): In the aspect of (1), the imaging camera may be disposed so that an inclination angle of the imaging camera is different from an inclination angle of the side display.

In this case, even when an orientation of the side display is set in consideration of effects of visibility, reflected light, and the like, the orientation of the imaging camera can be set to an angle suitable for the imaging range.

(5): In the aspect of (4), the inclination angle of the imaging camera may be set so that a face of an occupant is positioned at a center of an imaging range of the imaging camera in an up-down direction.

In this case, it becomes easier to include a face of the passenger, who is a subject, within the imaging range, and thus it is possible to capture an image that focuses on a facial expression of the subject.

(6): In the aspect of (1), the side display may be disposed at least on a passenger's seat side, and the imaging camera may be disposed on a passenger's seat side display.

In this case, a proportion of a steering wheel in the imaging range can be reduced compared to a case in which the imaging camera is disposed on the driver's seat side.

According to the aspects of the present invention, the entire interior of the vehicle cabin can be captured by the imaging camera without interfering with the driver's driving.

### BRIEF DESCRIPTION OF THE DRAWINGS

FIG. 1 is a perspective view schematically showing an interior of a vehicle cabin.

FIG. 2 is a perspective view showing an example of a display.

FIG. 3 is a perspective view of part A in FIG. 2.

FIG. 4 is a top view showing an example of an imaging camera in a side display.

FIG. 5 is a front view showing the example of the imaging camera in the side display.

FIG. 6 is a cross-sectional view taken along line B-B in FIG. 5.

FIG. 7 is a conceptual diagram showing an example of an imaging range of the imaging camera.

FIG. 8 is a block diagram showing an example of a processing step.

### DETAILED DESCRIPTION OF THE INVENTION

Hereinafter, the present invention will be described on the basis of preferred embodiments.

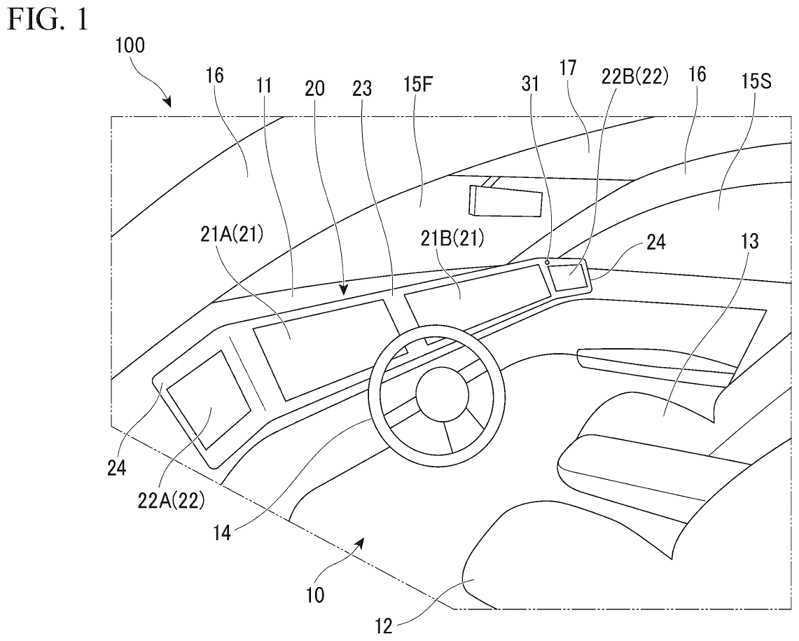

FIG. 1 is a perspective view schematically showing an interior of a vehicle cabin 10 of a vehicle 100 according to this embodiment.

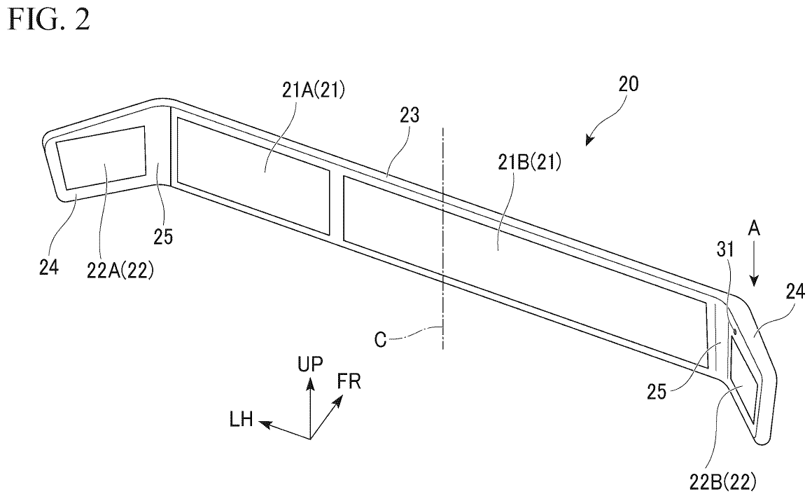

FIG. 2 is a perspective view showing an example of a display 20 disposed in the vehicle cabin 10. FIG. 2 shows an arrow UP pointing upward of the vehicle 100, an arrow FR pointing forward of the vehicle 100, and an arrow LH pointing to the left side of the vehicle 100.

The vehicle 100 includes an instrument panel 11, a driver's seat 12, a passenger's seat 13, a steering wheel 14, and the like within the vehicle cabin 10.

The driver's seat 12 is a seat that is disposed at the front of the vehicle 100 and is used by a driver. The passenger's seat 13 is a seat that is disposed next to the driver's seat 12 at the front of the vehicle 100 and is used by a passenger other than the driver. The driver's seat 12 and the passenger's seat 13 are front occupant's seats located at the front of the vehicle 100.

Although not specifically shown, one or more rows of passenger's seats may be provided behind the front occupant's seats in the vehicle cabin 10. A passenger sitting in the passenger's seat 13 may or may not assist the driver when the vehicle 100 is driven, and there may be no passenger in the passenger's seat 13. In the illustrated vehicle 100, the driver's seat 12 is disposed to the left of the passenger's seat 13, but the driver's seat 12 may be disposed to the right of the passenger's seat 13, opposite to the illustrated example. The number and arrangement of seats are not limited to those shown in the drawings and may be changed as appropriate.

The vehicle 100 includes a center display 21, a side display 22 for a side camera monitor system, and an imaging camera 31 that captures images of the interior of the vehicle cabin 10. The center display 21 in the illustrated example is mounted on the instrument panel 11. A front window 15F is disposed in front of the center display 21.

The display 20 in the illustrated example has the side displays 22 on the left and right of the center display 21. More specifically, the center display 21 includes a driver's seat side center display 21A and a passenger's seat side center display 21B. The side display 22 includes a driver's seat side display 22A and a passenger's seat side display 22B.

The driver's seat side center display 21A and the passenger's seat side center display 21B are disposed on a center display mounting portion 23 of the display 20. The side displays 22 are disposed on a side display mounting portion 24. In a preferred embodiment, the display 20 includes the center display mounting portion 23 and the side display mounting portion 24.

In the illustrated example of the center display 21, the driver's seat side center display 21A has a rectangular shape smaller than the passenger's seat side center display 21B, but the arrangement, shape, dimensions, and the like of each of the center displays 21 are not particularly limited. It is also possible to divide a display surface into a plurality of sections so that information for a driver and information for other passengers can be displayed on the same center display 21.

The imaging camera 31 is disposed above the side display 22 and on the center C side of the vehicle 100.

Above the side display 22 means a region above the side display 22 in an up-down direction of the vehicle 100. In a left-right direction, it may be disposed on the side display mounting portion 24, and it may be directly above the side display 22 or diagonally above it.

The center C side of the vehicle 100 means the side closer to the center C when the left-right direction of the side display 22 is divided into a side closer to the center C and a side farther from the center C. The center C of the vehicle 100 represents a position of a longitudinal central plane.

The side display 22 is a side display 22 for a side camera monitor system. The side camera monitor system is a confirmation device that captures an image of the rear of the vehicle from the outside of the vehicle 100 and is installed in a position at which it can be seen by the driver.

With the above-described configuration, the imaging camera 31 can capture an image of the interior of the vehicle cabin 10 from the side of the driver. Compared to a case in which the camera is installed in front of and above the center of the vehicle 100, the imaging camera 31 does not interfere with the driver's driving. Since the imaging camera 31 is unlikely to be hidden behind the bodies of the occupants at the front of the vehicle 100, the imaging camera 31 can capture an image of the entire interior of the vehicle cabin 10.

The display 20 in the illustrated example is a display module in which the center display 21 and the side display 22 are integrally mounted. A connection portion 25 between the center display 21 and the side display 22 is disposed therebetween. More specifically, the side display mounting portions are connected to the left and right sides of the center display mounting portion 23 via the connection portions 25. Although not specifically shown, the side display 22 equipped with the imaging camera 31 may be mounted in the vehicle 100 as a component separate from the center display 21.

The display 20 of this embodiment includes the center display 21, the side display 22 for a side camera monitor system, and the imaging camera 31 that captures an image of the interior of the vehicle cabin 10, and the imaging camera 31 is disposed above the side display 22 and on the center C side of the vehicle 100.

The imaging camera 31 is preferably disposed within a range in a height direction of the center display 21. In this case, since the imaging camera 31 does not protrude upward in the height direction of the center display 21, compared to a case in which the imaging camera 31 is disposed above the center display 21, the imaging camera 31 does not obstruct a driver's field of vision, or is unlikely to be mistaken for another object, and is unlikely to interfere with the driver's driving. Compared to a case in which the imaging camera 31 protrudes downward in the height direction of the center display 21, it is easier to arrange the imaging camera 31 to capture an image of the entire interior of the vehicle cabin 10.

A position of the imaging camera 31 shown in FIGS. 1 and 2 is a position of a light receiving part of the imaging camera 31. The light receiving part of the imaging camera 31 is disposed on the display surface side of the side display 22. Although not specifically shown, the imaging camera 31 may be provided with various mechanisms such as an image processing part on the back side of the light receiving part.

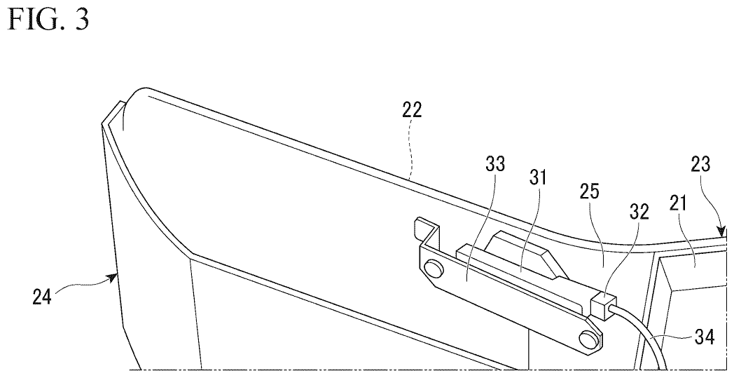

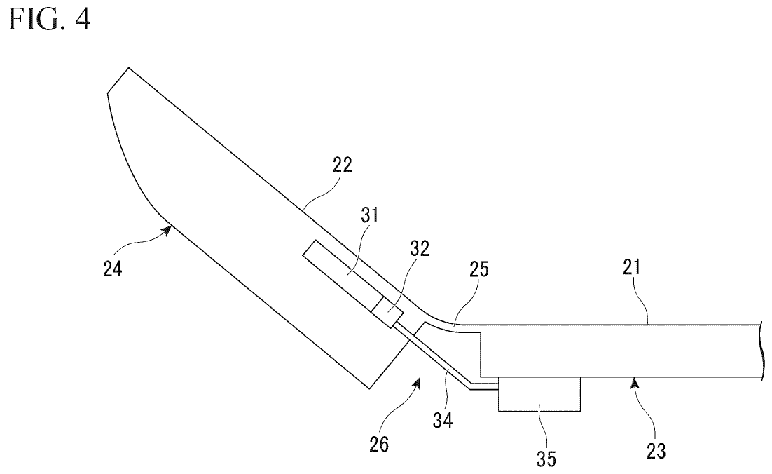

FIG. 3 is a perspective view of the side display 22 as seen from part A in FIG. 2. FIG. 4 is a top view showing the arrangement of the imaging camera 31 in the side display 22. In the drawings, illustration of configurations that do not require explanation may be omitted as appropriate.

As shown in FIG. 3, the imaging camera 31 has a connection terminal 32 such as a connector on the center display 21 side. A holder 33 fixes the imaging camera 31 to a front surface of the side display mounting portion 24. The imaging camera 31, like the center display 21 and the side display 22, receives a supply of electric energy from a power source within the vehicle 100. A cord 34 is connected to the connection terminal 32. The cord 34 is connected to the connection portion 35 on the center display 21 side.

The power source in the vehicle 100 may be a device that supplies electric energy to a power source in a vehicle equipped with the power source that is driven by electric energy, or may be a battery provided in a vehicle driven by an internal combustion engine. Examples of the vehicle equipped with a power source that is driven by electrical energy include electric vehicles, fuel cell vehicles (FCVs), and the like. The electric vehicles include battery electric vehicles (BEVs), hybrid electric vehicles (HEVs) equipped with an internal combustion engine that provides at least a part of their power, or plug-in hybrid electric vehicles (PHEVs).

The connection terminal 32 of the imaging camera 31 is preferably disposed in a region of the connection portion 25 between the center display 21 and the side display 22. In this case, even when the connection terminal 32 protrudes from the side display 22, it is accommodated in a recessed portion 26 between the center display 21 and the side display 22, and the connection terminal 32 is disposed to be hidden behind the display 20. Compared to a case in which the connection terminal 32 protrudes above the side display 22, or the like, the connection terminal 32 does not obstruct the driver's field of vision, and is less likely to be mistaken for another object, and is thus less likely to interfere with the driver's driving.

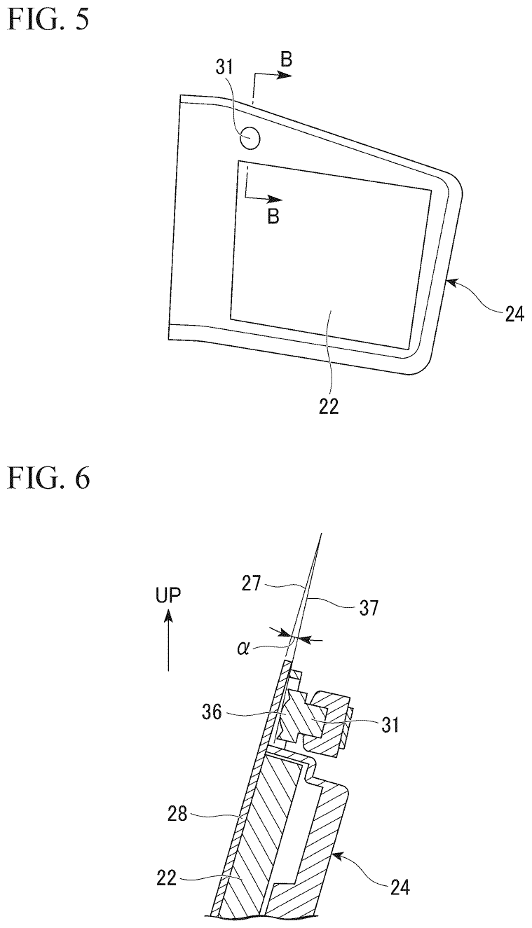

FIG. 5 is a front view showing the arrangement of the imaging camera 31 on the display surface side of the side display 22. FIG. 6 is a cross-sectional view taken along line B-B in FIG. 5. As shown in FIG. 6, the imaging camera 31 is preferably disposed so that an inclination angle 37 of the imaging camera 31 is different from an inclination angle 27 of the side display 22.

In the illustrated example, the inclination angle 27 is set along a display panel 28 that forms the display surface of the side display 22. The inclination angle 37 of the imaging camera 31 differs from the inclination angle 27 of the side display 22 via a difference in angle α. A magnitude of the angle α is not particularly limited.

The inclination angle 27 of the side display 22 is set in consideration of visibility from the driver's perspective, and effects of reflected light or the like on the driver. The inclination angle 27 is, for example, an angle at which the display surface of the display panel 28 is inclined with respect to the upper side of the vehicle.

The inclination angle 37 of the imaging camera 31 is set to an angle suitable for an imaging range since there is no need to improve visibility from the driver and other passengers. The inclination angle 37 is, for example, an angle at which a light receiving surface 36 of the imaging camera 31 is inclined with respect to the upper side of the vehicle. When the light receiving surface 36 is not a plane, the inclination angle 37 may be set along a plane perpendicular to an incident optical axis passing through the light receiving surface 36.

In the illustrated example, when the inclination angles 27 and 37 are defined as angles inclined with respect to the upper side of the vehicle, the inclination angle 37 of the imaging camera 31 is set to an angle smaller than the inclination angle 27 of the side display 22. Although not particularly shown, the inclination angle 37 of the imaging camera 31 may be set to an angle larger than the inclination angle 27 of the side display 22.

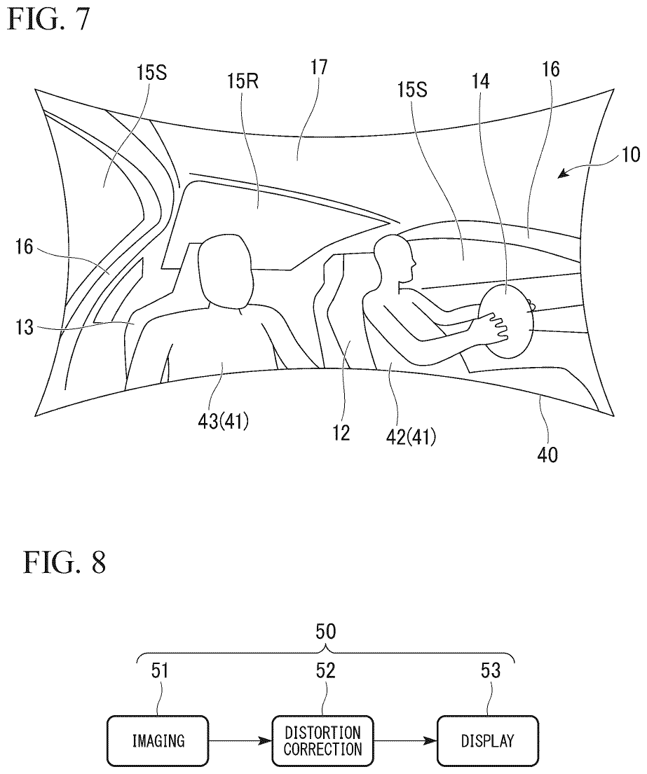

The inclination angle 37 of the imaging camera 31 may be set to match a viewpoint of an AM50 dummy. The AM50 dummy is a crash test dummy model that covers 50% of adult males in the United States. In this case, it becomes easier to include a face of the occupant sitting in the front occupant's seat within the imaging range of the imaging camera 31 (refer to the imaging range 40 in FIG. 7 described below), and thus it is easier to capture an image that focuses on a facial expression of the occupant as a subject. When the inclination angle 37 is set in accordance with the viewpoint of the dummy, and the inclination angles 27 and 37 are made different, the inclination angle 27 of the side display 22 is set to be different from the angle in accordance with the viewpoint of the dummy. A dummy used to adjust the inclination angle 37 (refer to a dummy 41 in FIG. 7 described below) is not limited to the AM50dummy, but may be set on the basis of a JM50 dummy (a model that covers 50% of Japanese adult males) or the like.

The viewpoint of the dummy may be a position at which a line of sight of the dummy placed on a seat faces, and may be a forward or sideward view. For example, when a face of the dummy is facing the side display 22, the light receiving part of the imaging camera 31 may be facing eyes of the dummy. When the face of the dummy is facing forward of the vehicle 100, the light receiving part of the imaging camera 31 may be directed toward the eyes of the dummy.

The imaging camera 31 is preferably disposed on the passenger's seat side display 22B. Compared to a case in which the imaging camera 31 is disposed on the driver's seat side display 22A, a proportion of the steering wheel 14 in the imaging range of the imaging camera 31 can be curbed. The imaging camera 31 may be disposed on both the driver's seat side display 22A and the passenger's seat side display 22B.

FIG. 7 is a conceptual diagram showing an example of the imaging range 40 of the imaging camera 31. The inclination angle 37 of the imaging camera 31 is preferably set so that the face of the occupant is positioned in the center of the imaging range 40 of the imaging camera 31 in the up-down direction. In the imaging range 40 of the illustrated example, images of a driver dummy 42 which is a dummy 41 installed in the driver's seat 12, a passenger dummy 43 which is a dummy 41 installed in the passenger's seat 13, and the like are captured. Preferably, faces (or a space between eyebrows, nose, or the like) of the driver dummy 42 and the passenger dummy 43 are disposed approximately in the center of the imaging range 40 in the up-down direction. A position of the face of the dummy 41 in the up-down direction of the imaging range 40 can be adjusted by changing the inclination angle 37 of the imaging camera 31. The dummy 41 used to adjust the imaging range 40 may be the dummy 41 placed in the driver's seat 12, the passenger's seat 13, or another position within the vehicle cabin 10, and moreover, a plurality of dummies may be used.

Furthermore, preferably, the imaging range 40 includes the steering wheel 14. Thus, it is possible to record a driving posture of the driver.

Furthermore, preferably, the imaging range 40 is large enough to obtain a bust shot including the chest of each of the dummies 41 that are the subjects. Thus, it is possible to record the facial expressions and upper body movements of the driver and passengers in the vehicle cabin 10.

Furthermore, preferably, the imaging range 40 includes vehicle windows such as side windows 15S and a rear window 15R. Thus, since scenery in the vehicle as it moves can be recorded, a situation outside the vehicle can be confirmed. In particular, an amount of light outside the vehicle can be used to check weather, time, and the like. These vehicle windows may be door windows or may be fixed to the vehicle body. These vehicle windows may be either openable or non-openable.

Furthermore, preferably, the imaging range 40 includes at least one of pillars 16 and a roof 17 within the vehicle cabin 10. Thus, the pillars 16 and the roof 17 function as a frame for an image of the driver and passengers, and a frame effect makes it easier for an observer watching the image to focus on movements of the driver and passengers.

FIG. 8 is a block diagram showing an example of a processing step for capturing an image using the imaging camera 31. A processing step 50 in the illustrated example includes an imaging step 51, a distortion correction step 52, and a display step 53. The imaging step 51 is a step of imaging an interior of the vehicle cabin 10, and can be performed using the imaging camera 31. As described above, preferably, the imaging range 40 includes scenery outside the vehicle. The image may be color or monochrome. Light used for capturing an image is not limited to visible light such as three primary colors (RGB), but may be infrared light or the like.

The distortion correction step 52 is a step of correcting a distortion of an image obtained in the imaging step 51. In the distortion correction step 52, an image processing circuit disposed outside the imaging camera 31 may be used, or an image processing circuit built into the imaging camera 31 may be used. The image processing circuit may be attached to the display 20.

The display step 53 is a step of displaying the image corrected in the distortion correction step 52. For the display step 53, the center display 21 or the side display 22 may be used. In the display step 53, the image may be displayed on a display outside the vehicle. For example, after the image obtained in the imaging step 51 or the image corrected in the distortion correction step 52 is stored in a storage device, the stored image may be displayed afterwards. After the images are transmitted to the outside of the vehicle by wireless communication or the like, the images received outside the vehicle may be displayed in real time or afterwards.

The present invention is not limited to the above-described embodiment, and various design modifications are possible without departing from the spirit and scope of the present invention. Examples of the vehicle include an automobile having a vehicle cabin. The automobile is not particularly limited, but examples thereof include automobiles with four to eight wheels, more specifically, passenger cars, trucks, and the like. The display equipped with the above-described imaging camera can also be applied to other moving bodies, transportation equipment, and the like.

What is claimed is:

1. A vehicle comprising:
a center display;
a side display for a side camera monitor system; and
an imaging camera configured to image an interior of a vehicle cabin,
wherein the imaging camera is disposed above the side display and on a center side of the vehicle.

2. The vehicle according to claim 1, further comprising a connection portion between the center display and the side display,
wherein the imaging camera is disposed within a range of the center display in a height direction.

3. The vehicle according to claim 2, wherein the imaging camera includes a connection terminal on a center display side, and the connection terminal is disposed in a range of the connection portion.

4. The vehicle according to claim 1, wherein the imaging camera is disposed so that an inclination angle of the imaging camera is different from an inclination angle of the side display.

5. The vehicle according to claim 4, wherein the inclination angle of the imaging camera is set so that a face of an occupant is positioned at a center of an imaging range of the imaging camera in an up-down direction.

6. The vehicle according to claim 1, wherein the side display is disposed at least on a passenger's seat side, and
the imaging camera is disposed on a passenger's seat side display.
